(19) United States
(12) Patent Application Publication
(10) Pub. No.: US 2017/0277150 A1
(43) Pub. Date: Sep. 28, 2017

(54) MOTOR CONTROLLER HAVING FUNCTION OF REDUCING VIBRATION

(71) Applicant: FANUC CORPORATION, Yamanashi (JP)

(72) Inventors: Tsutomu Nakamura, Yamanashi (JP); Satoshi Ikai, Yamanashi (JP)

(73) Assignee: FANUC CORPORATION, Yamanashi (JP)

(21) Appl. No.: 15/458,088

(22) Filed: Mar. 14, 2017

(30) Foreign Application Priority Data
Mar. 25, 2016 (JP) 2016-062758

(51) Int. Cl. G05B 19/048

(52) U.S. Cl. CPC G05B 19/048; G05B 2219/39199

(57) ABSTRACT

A motor controller according to the present invention includes a position command unit for commanding the position of a driven unit, a compensation filter unit for compensating a position command, and a servo control unit for controlling the operation of a servomotor based on a compensated position command. The compensation filter unit includes an inverse characteristic filter for approximating an inverse characteristic of a transfer characteristic from a motor position to a mechanical position, and a high frequency cutoff filter for reducing a high frequency component of the position command. The inverse characteristic filter is a filter for reducing a gain at a mechanical resonance frequency ω₀. The high frequency cutoff filter has a constant “a” times high frequency cutoff frequency aω₀ using a constant “a” of 1 or more, with respect to the mechanical resonance frequency ω₀ determined in the inverse characteristic filter.

This application is a new U.S. patent application that claims benefit of JP 2016-062758 filed on Mar. 25, 2016, the content of 2016-062758 is incorporated herein by reference.

### BACKGROUND OF THE INVENTION

1. Field of the Invention

The present invention relates to a motor controller, and more specifically relates to a motor controller having the function of reducing vibration.

2. Description of Related Art

Motor controllers for driving machines having motors conventionally deal with high frequency resonance using low-pass filters or notch filters provided in servo control systems. These filters are disposed in control loops of servomechanisms, and do not aim at compensating position commands but at improving the responsivity and stability of the servomechanisms.

On the other hand, as measures against low frequency resonance, using a smooth command (for example, Japanese Unexamined Patent Publication (Kokai) No. 2009-237916), applying a notch filter to a command, using input shaping to a command (for example, “Preshaping Command Inputs to Reduce System Vibration”, Massachusetts Institute of Technology Artificial Intelligence Laboratory A. I. Memo No. 1027 (AIM-1027), 1998-01-01), and the like have been conventionally taken. These measures, in contrast to the measures against high frequency resonance, determine the position commands to be applied to the servo control systems so as to have sufficiently reduced energy of frequencies at which mechanical systems vibrate.

The motor controllers of machine tools generally perform both of PTP (point-to-point) control that is not concerned with travel paths, and trajectory control that controls the positions of machines in accordance with the travel paths. The present invention is an invention relating to the latter, i.e., trajectory control. When the motor controllers perform the trajectory control, it is not desired that the servo control systems widely deviate from commands programmed by users.

It is now taken as an example that a time series of position commands is applied to a servo control axis. The object of a servo control system is to operate a machine in accordance with the time series of position commands. However, the machine sometimes cannot be operated in accordance with the position commands due to the effect of mechanical resonance. The mechanical resonance causes residual vibration after stopping the axis, and, if a machine tool is in process, may leave cutter marks in a processed workpiece.

When using the conventional techniques such as the notch filter and the input shaping, the notch filter or the input shaping cuts an energy component corresponding to a resonance frequency, thus reducing the residual vibration. However, these filters change a commanded trajectory in exchange for a reduction in the residual vibration. Thus, a machine does not work in accordance with the commanded trajectory. For example, when a notch filter is applied to a command, an overshoot generally occurs. This is easily understood because a step response of the notch filter causes the overshoot. When the commanded trajectory overshoots due to the use of the notch filter, traces are left in a processed workpiece in accordance with the overshoot, thus causing a reduction in processing integrity.

### SUMMARY OF THE INVENTION

The present invention aims at providing a motor controller that, assuming a model of a two-inertia system, can operate a load side of the two-inertia system with well suppressed vibrations in semi-closed control.

A motor controller according to an embodiment of the present invention is a motor controller that compensates an elastic deformation between a servomotor and a driven unit driven by the servomotor. The motor controller includes a position command unit for commanding the position of the driven unit, a compensation filter unit for compensating a position command outputted from the position command unit, and a servo control unit for controlling the operation of the servomotor based on a compensated position command outputted from the compensation filter unit. The compensation filter unit includes an inverse characteristic filter for approximating an inverse characteristic of a transfer characteristic from a motor position to a mechanical position, and a high frequency cutoff filter for reducing a high frequency component of the position command. The inverse characteristic filter is a filter for reducing a gain at a mechanical resonance frequency ω₀. The high frequency cutoff filter has a constant “a” times high frequency cutoff frequency aω₀ using a constant “a” of 1 or more, with respect to the mechanical resonance frequency ω₀ determined in the inverse characteristic filter.

### BRIEF DESCRIPTION OF THE DRAWINGS

The objects, features, and advantages of the present invention will be more apparent from the following description of an embodiment in conjunction with the attached drawings, wherein:

FIG. 1 is a block diagram of a motor controller according to an invention relating to the present invention;

FIG. 2 is a graph of the characteristic of a second-order low-pass filter in which a mechanical resonance frequency ω₀ is determined as a cutoff frequency;

FIG. 3 is a block diagram of a motor controller according to an embodiment of the present invention;

FIG. 4 is a graph of the characteristic of time series data of a moving average filter; and

FIG. 5 is a graph of frequency characteristic data of the moving average filter.

### DETAILED DESCRIPTION OF THE INVENTION

A motor controller according to the present invention will be described below with reference to the drawings.

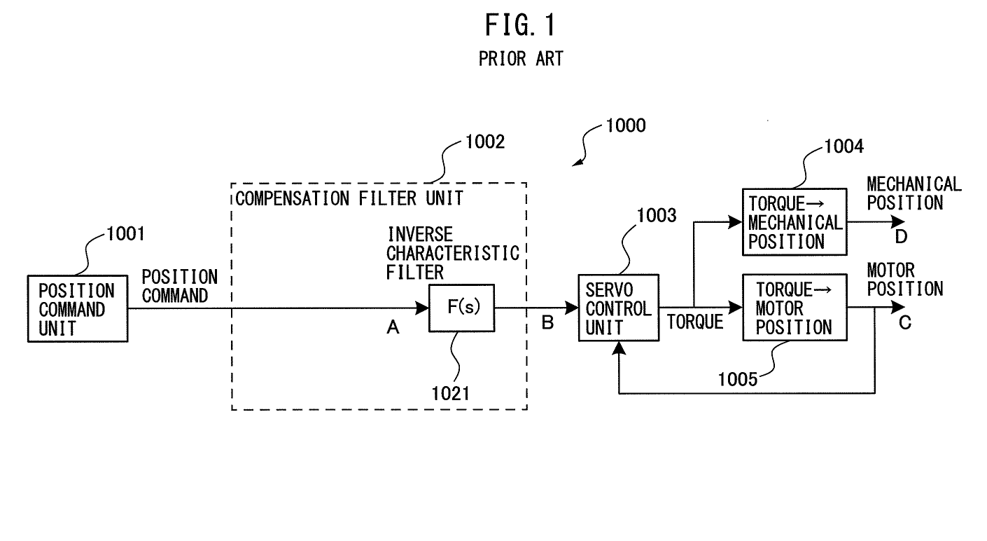

An invention relating to the present invention, that is, an invention of a related application (Japanese Unexamined Patent Publication (Kokai) No. 2015-007219) submitted by this applicant will be described. FIG. 1 is a block diagram of a motor controller according to the invention relating to the present invention. The motor controller according to the related invention compensates a position command using an inverse characteristic filter F(s) from a motor position to a mechanical position.

A motor controller 1000 shown in FIG. 1 includes a position command unit 1001, a compensation filter unit 1002, a servo control unit 1003, an element 1004 representing a transfer characteristic from torque to a mechanical position, and an element 1005 representing a transfer characteristic from the torque to a motor position.

In FIG. 1, a position command generated by the position command unit 1001 is inputted to the compensation filter unit 1002. The compensation filter unit 1002 outputs a compensated position command, that is, a position command after compensation. The servo control unit 1003 outputs torque based on the compensated position command to control the operation of a motor (not shown).

An overview of the motor controller shown in FIG. 1 according to the related invention is as follows.

Since the motor controller 1000 is a motor control system of a semi-closed configuration, the motor controller 1000 has a fast response due to the use of feedforward control. That is, in FIG. 1, a transfer characteristic from the compensated position command (B) to the motor position (C) is desired to be made approximately 1.

The related invention aims at improving a transfer characteristic from the position command (A) to the mechanical position (D). That is, a transfer characteristic from the position command (A) to the mechanical position (D) is desired to be close to approximately 1.

For the above purpose, a filter having an inverse characteristic from the motor position (C) to the mechanical position (D) is applied to the position command (A).

According to the motor controller of the above related invention, the use of a two-inertia system, that is, a vibration model for deriving the inverse characteristic filter allows position control having less residual vibration.

As to the concrete derivation of the inverse characteristic filter according to the related invention, the inverse characteristic filter F(s) of the transfer characteristic from the motor position (C) to the mechanical position (D) is derived in the two-inertia system as the following equation (1):

$$F ( s ) = \frac{{s}^{2} + 2 ζ {ω}_{0} s + {ω}_{0}^{2}}{2 {ζω}_{0} s + {ω}_{0}^{2}} \qquad ( 1 )$$

wherein, ω₀ is a mechanical resonance frequency, and ζ is a damping factor.

Although a deviation is omitted in the related application, a transfer characteristic G(s) from the motor position (C) to the mechanical position (D) is represented by the following equation (2):

$$G ( s ) = \frac{2 ζ {ω}_{0} s + {ω}_{0}^{2}}{{s}^{2} + 2 {ζω}_{0} s + {ω}_{0}^{2}} \qquad ( 2 )$$

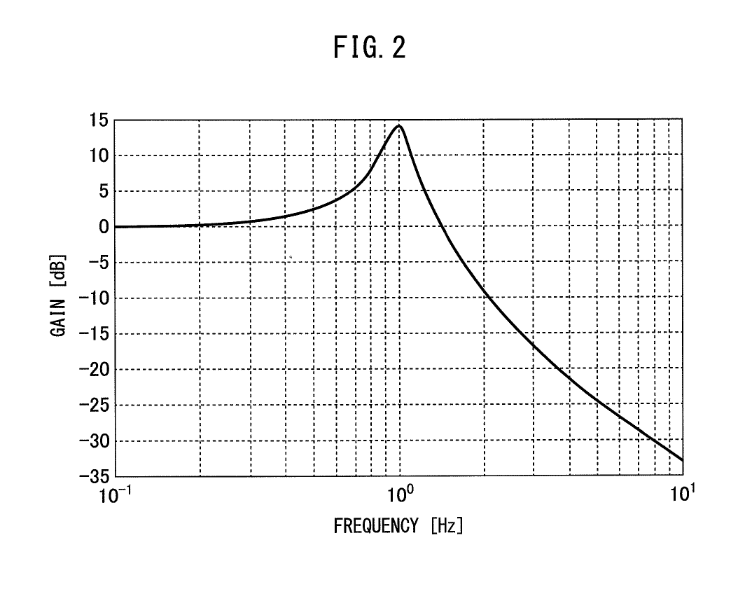

The transfer characteristic from the motor position (C) to the mechanical position (D) of FIG. 1 is represented as a second-order low-pass filter in which a mechanical resonance frequency (hereinafter also simply called “resonance frequency”) ω₀ is determined as a cutoff frequency. By way of example, FIG. 2 shows a characteristic in the case of ω₀=1 [Hz] and ζ=0.1. In FIG. 2, a horizontal axis represents frequency [Hz], and a vertical axis represents gain [dB].

According to FIG. 2, the transfer characteristic from the motor position (C) to the mechanical position (D) has the following two features:

(i) The gain is 0 [dB] or more at the resonance frequency ω₀. This causes the vibration of a mechanical system at the frequency ω₀.

(ii) The gain is reduced at frequencies sufficiently higher than the resonance frequency ω₀. Thus, a system having low frequency resonance does not respond to the frequencies sufficiently higher than the resonance frequency ω₀.

To eliminate the above two features, the related application makes a compensation using the inverse characteristic filter to the characteristic shown in FIG. 2.

By the way, due to the above feature (ii), the mechanical system having low frequency resonance does not respond to the frequencies sufficiently beyond the resonance frequency ω₀. In such a machine, position control is preferably applied to a smooth position command in which the frequencies (at which the mechanical system originally does not respond) sufficiently beyond the resonance frequency ω₀ are cut off from the frequency characteristic of the position command.

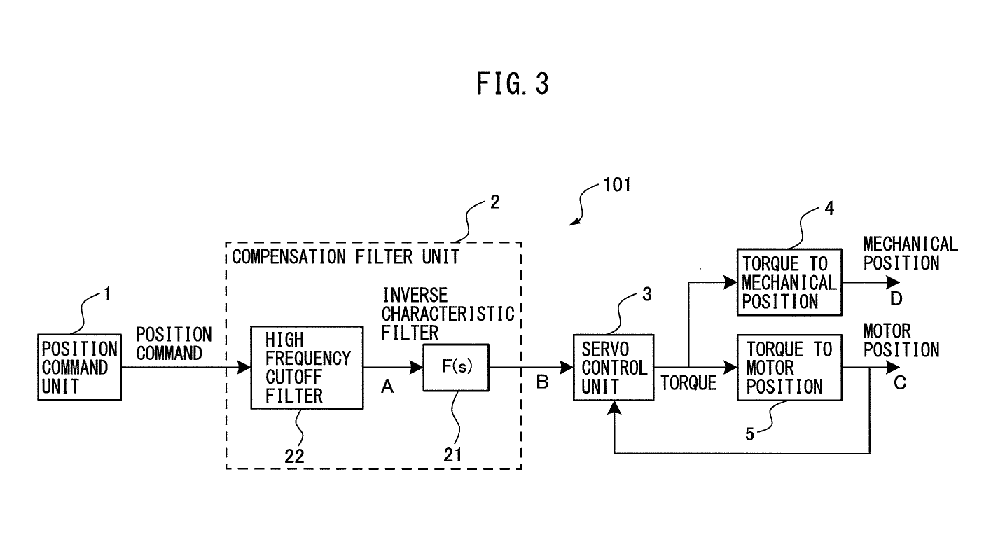

Therefore, in a motor controller 101 according to the present invention, as shown in a block diagram of FIG. 3, a compensation filter unit 2 to be applied to a position command includes a high frequency cutoff filter 22 to ensure the smoothness of the position command, as well as an inverse characteristic filter 21. The motor controller 101 according to an embodiment of the present invention is a motor controller that compensates an elastic deformation between a servomotor (not shown, hereinafter also simply called “motor”) and a driven unit (not shown) driven by the servomotor. The motor controller 101 includes a position command unit 1, the compensation filter unit 2, and a servo control unit 3. The compensation filter unit 2 includes the inverse characteristic filter 21 and the high frequency cutoff filter 22. The motor controller 101 further includes an element 4 representing a transfer characteristic from torque to a mechanical position, and an element 5 representing a transfer characteristic from the torque to a motor position.

The position command unit 1 commands the position (mechanical position (D)) of the driven unit. A position command generated by the position command unit 1 is inputted to the compensation filter unit 2.

The compensation filter unit 2 compensates the position command outputted from the position command unit 1. The compensation filter unit 2 outputs a compensated position command, that is, the position command after compensation. The underlying idea of the present invention is to change the commanded position of the motor commanded by a host controller (not shown), for the purpose of controlling a load position with high accuracy. Therefore, the motor controller according to the present invention compensates the position command from the host controller.

The servo control unit 3 controls the operation of the servomotor (motor) based on the compensated position command outputted from the compensation filter unit 2. By the operation of the motor, a machine is operated through a transmission mechanism (not shown).

The inverse characteristic filter 21 approximates an inverse characteristic of a transfer characteristic from the motor position (C) to the mechanical position (D). The inverse characteristic filter 21 is a filter that reduces a gain at a mechanical resonance frequency ω₀. Note that, this embodiment uses the inverse characteristic filter. Using the inverse characteristic filter provides an advantage of program implementation.

The high frequency cutoff filter 22 reduces a high frequency component of the position command. The high frequency cutoff filter 22 has an “a” times high frequency cutoff frequency aω₀ using a constant “a” of 1 or more, with respect to the mechanical resonance frequency ω₀ determined in the inverse characteristic filter 21. Although the value of “a” depends on mechanical stiffness and modeling accuracy, values of the order of approximately 1 to 5 are appropriate. The high frequency cutoff filter 22 may be a low-pass filter.

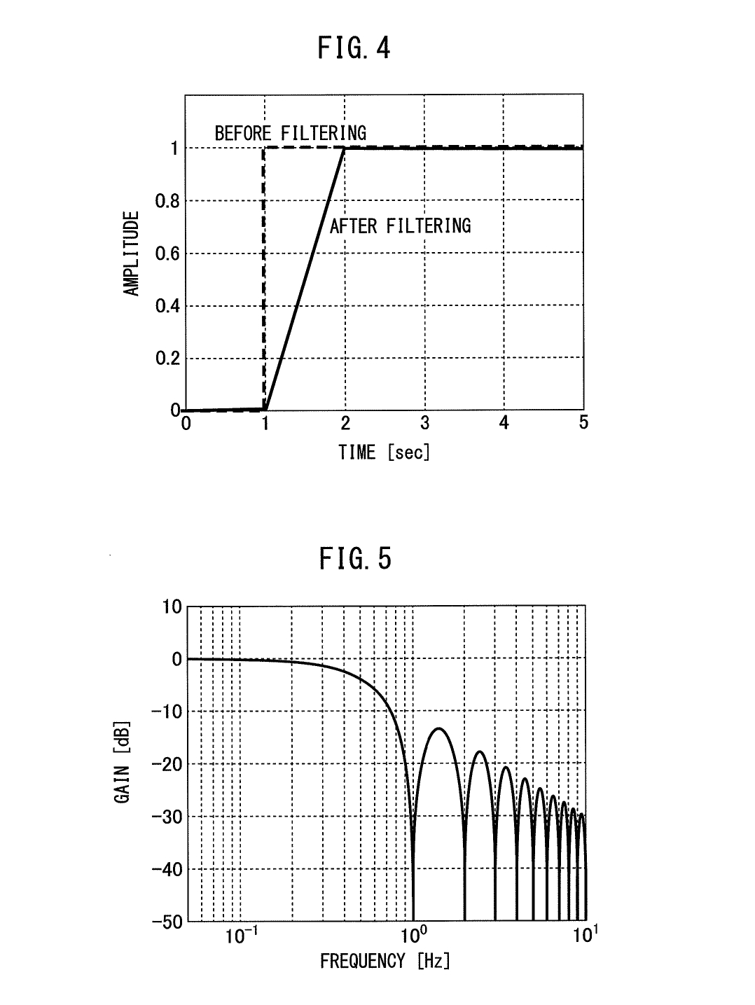

The high frequency cutoff filter 22 may be a moving average filter. The moving average filter has the same configuration as the simplest configuration of a technique called input shaping, and has a comb-shaped frequency characteristic. By way of example, FIG. 4 shows time-series data of a moving average filter of one second. In FIG. 4, the horizontal axis represents time [sec], and the vertical axis represents amplitude. FIG. 5 shows frequency characteristic data of the moving average filter. In FIG. 5, the horizontal axis represents frequency [Hz], and the vertical axis represents gain [dB].

In the block diagram of the motor controller according to the embodiment of the present invention, as shown in FIG. 3, the inverse characteristic filter 21 basically reduces the gain of mechanical resonance. However, when the inverse characteristic filter 21 cannot sufficiently reduce vibration due to a modeling error or the like, the use of the moving average filter having the comb-shaped frequency characteristic as the high frequency cutoff filter 22 is effective. To be more specific, when using a moving average filter of a=1, the comb-shaped gain reduction effect of the moving average filter can be used for reducing vibration. The present invention relates to a control configuration having both of the inverse characteristic filter 21 and the high frequency cutoff filter 22. However, especially determining at a=1, the moving average filter used as the high frequency cutoff filter 22 has the effect of input shaping.

The inverse characteristic filter 21 is represented by the above equation (1) using the mechanical resonance frequency ω₀ and a damping factor ζ. The present invention treats the value of ζ, which corresponds to a damper constant, as a non-zero value in a second-order standard system. Since vibrations necessarily attenuate in an actual machine, the motor controller according to the present invention, which has an adjustment parameter corresponding to the damper constant, has the beneficial effect of reducing vibration.

According to the motor controller of the embodiment of the present invention, it is possible to provide the motor controller that, assuming the model of the two-inertia system, can operate the load side of the two-inertia system with well suppressed vibration in semi-closed control.

What is claimed is:

1. A motor controller for compensating an elastic deformation between a servomotor and a driven unit driven by the servomotor, comprising:
a position command unit for commanding the position of the driven unit;
a compensation filter unit for compensating a position command outputted from the position command unit; and
a servo control unit for controlling the operation of the servomotor based on a compensated position command outputted from the compensation filter unit, wherein
the compensation filter unit includes:
an inverse characteristic filter for approximating an inverse characteristic of a transfer characteristic from a motor position to a mechanical position; and
a high frequency cutoff filter for reducing a high frequency component of the position command,
the inverse characteristic filter is a filter for reducing a gain at a mechanical resonance frequency ω₀, and
the high frequency cutoff filter has a constant “a” times high frequency cutoff frequency aω₀ using a constant “a” of 1 or more, with respect to the mechanical resonance frequency ω₀ determined in the inverse characteristic filter.

2. The motor controller according to claim 1, wherein the high frequency cutoff filter is a moving average filter.

3. The motor controller according to claim 1, wherein the high frequency cutoff filter is a low-pass filter.

4. The motor controller according to claim 2, wherein the constant “a” is 1.

5. The motor controller according to claim 1, wherein the inverse characteristic filter is represented by the following equation using the mechanical resonance frequency ω₀ and a damping factor ζ:
$$F ( s ) = \frac{{s}^{2} + 2 ζ {ω}_{0} s + {ω}_{0}^{2}}{2 {ζω}_{0} s + {ω}_{0}^{2}}$$
